(19) United States
(12) Patent Application Publication
(10) Pub. No.: US 2022/0239326 A1
(43) Pub. Date: Jul. 28, 2022

(54) MOBILE DEVICE CASE WITH STORAGE COMPARTMENT

(71) Applicant: Vinci Brands LLC, Tustin, CA (US)

(72) Inventors: Dailyn Kim, Irvine, CA (US); Sung Truong, Newport Beach, CA (US); Cody Brooner, Laguna Niguel, CA (US); Peter Tu, Long Beach, CA (US); Timothy Hemesath, Clovis, CA (US)

(73) Assignee: Vinci Brands LLC, Tustin, CA (US)

(21) Appl. No.: 17/659,661

(22) Filed: Apr. 18, 2022

Related U.S. Application Data
(63) Continuation of application No. 17/517,665, filed on Nov. 2, 2021.
Application No. 17/517,665 is a continuation of application No. 17/353,806, filed on Jun. 21, 2021, now abandoned.
Application No. 17/353,806 is a continuation of application No. 17/195,629, filed on Mar. 8, 2021, now abandoned.
Application No. 17/195,629 is a continuation-in-part of application No. 17/033,677, filed on Sep. 25, 2020, now abandoned.
Application No. 17/033,677 is a continuation-in-part of application No. 29/723,718, filed on Feb. 10, 2020, now Pat. No. D916072.
Application No. 29/723,718 is a division of application No. 29/631,305, filed on Dec. 28, 2017, now Pat. No. D875089.
Application No. 17/033,677 is a continuation-in-part of application No. 16/353,960, filed on Mar. 14, 2019, now abandoned.
Application No. 16/353,960 is a continuation of application No. 15/295,316, filed on Oct. 17, 2016, now Pat. No. 10,236,928.
Application No. 17/195,629 is a continuation-in-part of application No. 17/103,945, filed on Nov. 24, 2020, now abandoned.
Application No. 17/103,945 is a continuation of application No. 16/787,001, filed on Feb. 10, 2020, now abandoned.
Application No. 16/787,001 is a continuation-in-part of application No. 16/277,681, filed on Feb. 15, 2019, now Pat. No. 10,555,589.
Application No. 16/277,681 is a continuation of application No. 15/865,246, filed on Jan. 8, 2018, now Pat. No. 10,206,471.
(60) Provisional application No. 62/274,567, filed on Jan. 4, 2016.
(60) Provisional application No. 62/906,076, filed on Sep. 25, 2019.
(60) Provisional application No. 62/442,977, filed on Jan. 6, 2017.

(51) Int. Cl. H04B 1/3888

(52) U.S. Cl. CPC H04B 1/3888

(57) ABSTRACT

A protective case for a mobile device that includes a mobile device cavity that is configured to receive and retain a mobile device and an internal storage compartment is disclosed herein. In some embodiments, the case has a molded multi-layered construction. In such embodiments, the exterior back surface of the case may be configured to conceal the existence of the storage compartment or may alternatively be transparent to facilitate scanning of personal items held in the storage compartment without requiring removal therefrom. In some embodiments, the protective case provides different user viewing operating positions while minimizing bulkiness and weight.

### CROSS-REFERENCE TO RELATED APPLICATIONS

This application is a continuation of U.S. patent application Ser. No. 17/517,665, filed on Nov. 2, 2021, which is a continuation of U.S. patent application Ser. No. 17/353,806, filed on Jun. 21, 2021, which is a continuation of U.S. patent application Ser. No. 17/195,629 filed on Mar. 8, 2021, which is a continuation-in-part of U.S. patent application Ser. No. 17/033,677, filed on Sep. 25, 2020, which is a continuation-in-part of U.S. Design patent application Serial No. 29/723,718, flied on Feb. 10, 2020, which is a divisional of U.S. Design patent application Serial No. 29/631.305, filed on Dec. 28, 2017 and issued as U.S. Design Patent. No. D875,089 on Feb. 11, 2020; U.S. patent application Ser. No. 17/033,677 is also a continuation-in-part of U.S. patent application Ser. No. 16/353,960, filed on Mar. 14, 2019, which is a continuation of U.S. patent application Ser. No. 15/295316, filed on Oct. 17, 2016 and issued as U.S. Pat. No. 10,236,928 on Mar. 19, 2019, which claims the benefit of and priority to U.S. Provisional Patent Application Ser. No. 62/274,567, filed on Jan. 4, 2016; U.S. patent application Ser. No. 17/033,677 also claims the benefit of and priority to U.S. Provisional Patent application Ser. No. 62/906,076, filed on Sep. 25, 2019; and U.S. patent application Ser. No. 17/195,629 is also a continuation-in-part of U.S. patent application Ser. No. 14/103,945, filed on Nov. 24, 2020, which is a continuation of U.S. patent application Ser. No. 16/787,001, filed on Feb. 10, 2020, which is a continuation-in-part of U.S. patent application Ser. No. 16/277,681, filed on. Feb. 15, 2019 and issued as U.S. Pat. No. 10,555,589 on Feb. 11, 2020, which is a continuation of U.S. patent application Ser. No. 15/865,246, filed on Jan. 8, 2018 and issued as U.S. Pat. No. 10,206,471 on Feb. 19, 2019, which claims the benefit of and priority to U.S. Provisional Patent application Serial No. 62/442,977, filed on Jan. 6, 2017. The entirety of each of the foregoing applications is hereby incorporated herein by reference.

### FIELD OF THE INVENTION

The present disclosure relates to user removable protective cases and enclosures for mobile devices and, more particularly, to such cases that have a storage compartment.

### DESCRIPTION OF THE RELATED ART

Mobile devices, such as smartphones, tablets, laptops, and the like are known to sustain damage from impact and from contamination as a result of the ingress of water or other fluids. Such damage may result, for example, in a cracked screen, scratches on a finished surface, lost or damaged buttons or controls, cracked or bent external body components, and/or failed or malfunctioning electrical components. Protective cases can protect mobile devices from such damage and other types of damage.

While some protective cases for mobile devices include storage compartments, such cases often are bulky, accentuate the shape and existence of the compartment, and lack durability. The cases may also include panels and drawers that can be relatively difficult or costly to manufacture. Accordingly, there remains a need for an improved mobile device case with a storage compartment that has a superior configuration to prior art cases and that is more readily constructed and assembled.

### SUMMARY

A protective case for a mobile device that includes a mobile device cavity that is configured to receive and retain a mobile device and an internal storage compartment is disclosed herein. In some embodiments, the case has a molded multi-layered construction. In such embodiments, the exterior back surface of the case may be configured to conceal the existence of the storage compartment or may alternatively be transparent to facilitate scanning of personal items held in the storage compartment without requiring removal therefrom. In some embodiments, the protective ease provides different user viewing/operating positions while minimizing bulkiness and weight.

### BRIEF DESCRIPTION OF THE DRAWINGS

FIGS. 1A and 1B are front and rear perspective views, respectively, of a first embodiment of the protective case for a mobile device with the groove-rail configuration with the mobile device received within the case.

FIG. 1C′ is a perspective view of a protective case of FIGS. 1A-1B with the mobile device removed from the case to allow greater visibility into the construction and interior surface that defines the device cavity or compartment and the storage cavity residing underneath.

FIGS. 1D-1F are front face, back-right, and back-left face perspective views, respectively, of the protective case illustrated in FIG. 1e showing the two component layers of the case separated from one another to better illustrate the molded construction and configuration of each of the layers and their relative configuration to one another.

FIGS. 2A-2B show a perspective view of the first embodiment of the protective case with the removable portion closed and open, respectively.

FIGS. 3A-3B show the detent and tab of the first embodiment of the protective case, and an exploded view thereof, respectively.

FIG. 4 shows the first embodiment of the protective case and various exploded views thereof.

FIG. 5 shows the first embodiment of the protective case with the various layers of the fixed portion and the removable portion separated for clarity.

FIG. 6 shows a second embodiment of the protective case with the groove-rail configuration with the various layers of the fixed portion and the removable portion separated for clarity.

FIG. 7 shows a front view of the second embodiment of the protective case with the removable portion open.

FIG. 8 is a cross-sectional view of a first embodiment of the protective case containing a mobile device and a credit card in a stand configuration.

FIG. 9 is a cross-sectional view of the embodiment of the protective case shown in FIG. 8 containing a mobile device and a credit card in a closed configuration.

Each drawing is generally 10 scale and hence relative dimensions of the various layers may be determined from the drawings.

### DETAILED DESCRIPTION OF THE ILLUSTRATED EMBODIMENTS

Protective cases that are configured to receive, retain, and protect a mobile device, providing both a high level of protection and a storage compartment, are disclosed herein.

Mobile devices suitable for use with the disclosed protective cases typically include flat front and back faces that define the height or thickness of the mobile device and a perimeter defined by sides extending between the front and back faces on the top, bottom, right, and left sides of the mobile device, so as to define corners at the intersecting regions of the sides, where the corners may be rounded. The ease may be configured for a mobile device that is in the form of a tablet, a mobile phone, a gaming device, or another portable handheld electronic device. Various aspects of the structure, construction, configuration, use, and manufacture of the disclosed protective cases are summarized below.

In some embodiments, the case may be formed of a molded integrated construction that defines the interior and exterior surfaces of the case, front and opposing back face walls of the case, and left, right, bottom, and top side walls of the case. The interior surface of the front face wall is configured to be in contact with and extend over the perimeter edge of the front face of the mobile device when the mobile device is hilly received within the case so as to retain the mobile device within the case. The front face wall includes an aperture that has nearly the same dimensions as but is slightly smaller than the front face of the mobile device that it is configured to retain, such that a mobile device may be readily inserted into or removed from the case and also may be properly retained and secured within the case after it is inserted into the case. The interior surface of the back face wall is configured to be in contact with the back face of the mobile device and cover the back of the device and the interior surfaces of the sidewalls are configured to be in contact and protect the corresponding sides of the mobile device.

The interior surfaces of the walls of the case thus define a mobile device compartment or cavity that is configured to receive and retain a mobile device within the case. The interior surface also defines a storage compartment that may be formed into the back face wall of the case. The storage compartment may be dimensioned to receive credit cards, personal identification such as a driver's license, or other similar personal items and may open, partially or entirely, into the mobile device compartment/cavity.

The back face wall of the case includes a flat exterior surface region that extends along a first plane and a perimeter exterior surface region that extends around that flat exterior surface region. The flat exterior surface region of the back face wall is configured so as to not extend to the perimeter of the mobile device. Rather, the perimeter surface region includes a transition surface that is configured to extend from the external flat surface to the intersection between the back face of the device and the top, bottom, right, and/or left sides of the mobile device. The transition surface extends away from the plane that defines the flat exterior surface region toward the front face wall of the case and does not include surfaces that are parallel to the flat exterior surface. The storage compartment residing thereunder is thereby capable of being, concealed by the exterior shape of the back face wall.

In some embodiments, the case includes an upper portion and a lower portion, where the lower portion is coupled to the upper portion at the back face wall, in some embodiments, the lower portion may be coupled to the upper portion by a hinge. In such embodiments, the lower portion is smaller than the upper portion and is integrally coupled to the upper portion at the hinge but disconnected from the upper portion at the sidewalls. The disconnection between the upper and lower portions may be imparted by the molding process or may be mechanically imparted after molding during the finishing process by mechanical or laser cutting or another suitable process.

In such embodiments, the upper and lower portions and hinge are configured to allow the lower portion to rotate backward over the exterior surface of the back face wall of the upper portion of the case but limit forward rotation. When the lower portion is rotated backwards, the storage compartment becomes accessible to the user. The flat exterior surface and surrounding transition surface may extend to both the upper and lower portions of the case and are defined by the exterior surface of the back face wall on each of those portions.

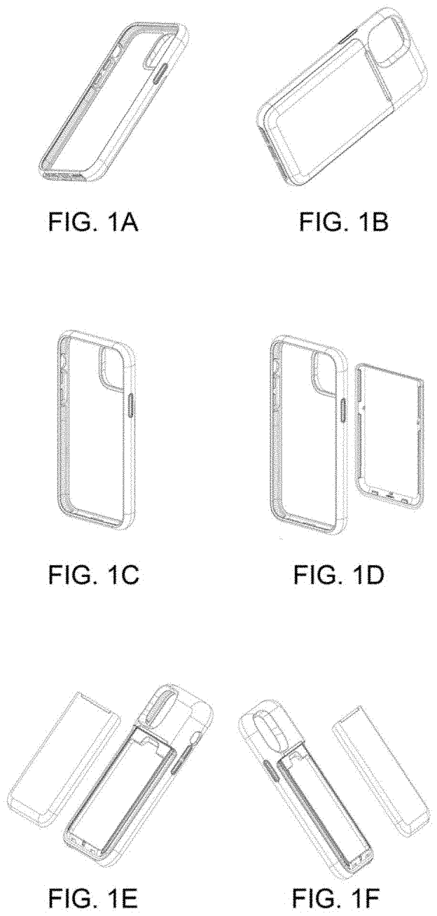

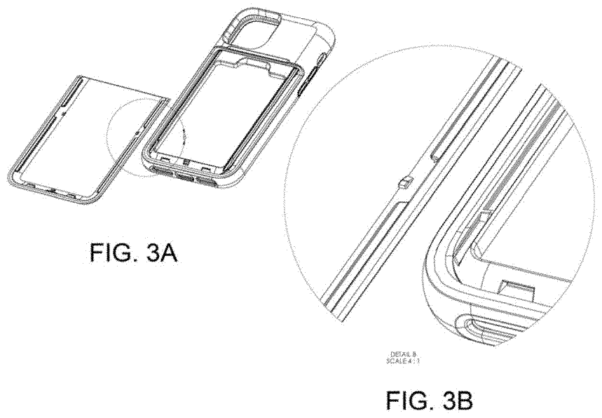

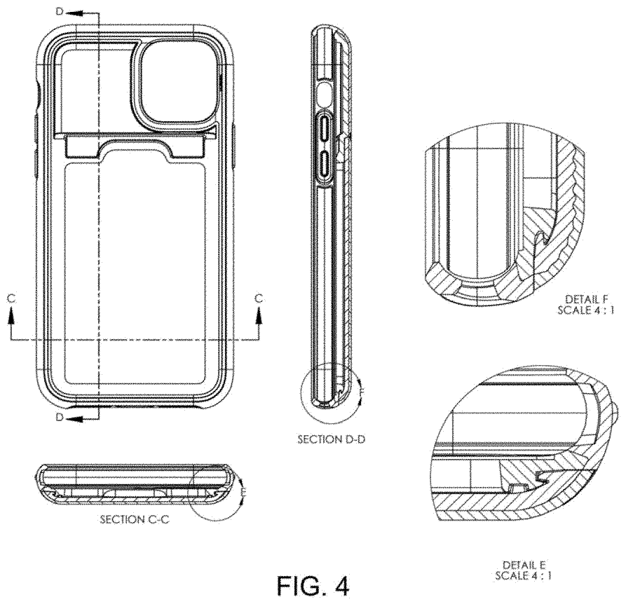

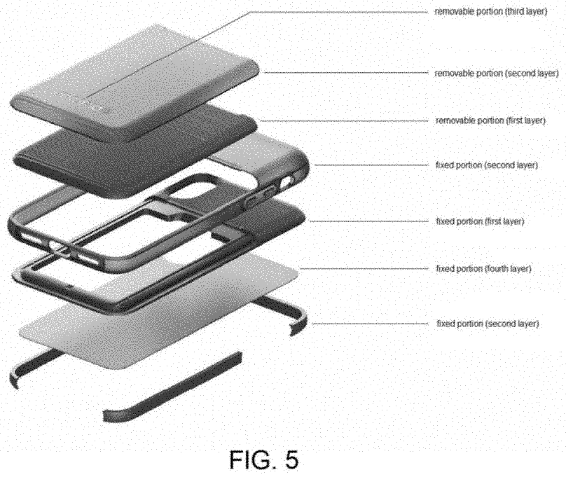

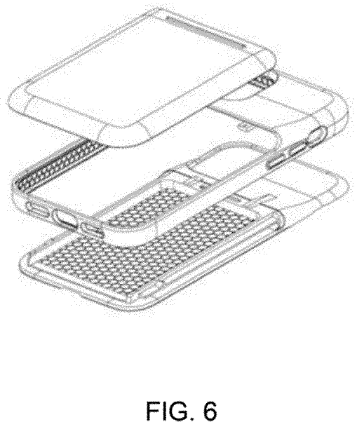

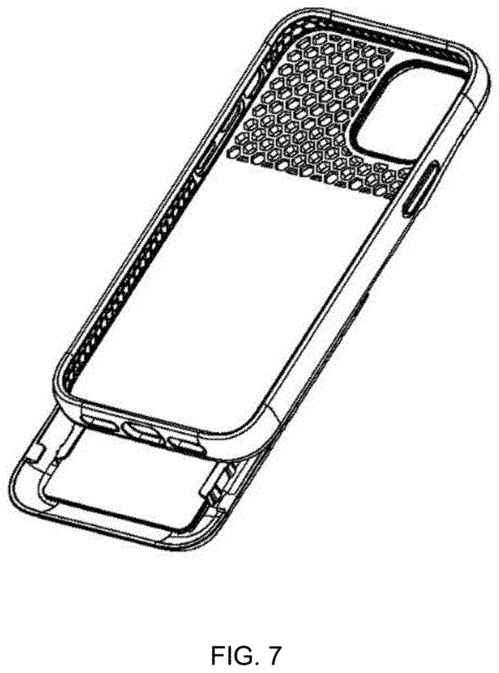

In some alternate embodiments, the case includes a fixed portion and a removable portion, where the removable portion is coupled to the fixed portion at the hack face wall. Such embodiments are shown in FIGS. 1-7. The removable portion may be coupled to the fixed portion by a groove-rail system, where a primary groove formed from an extension that protrudes from the back surface of each of the left and right side walls and a corresponding rail on each side of the removable portion that is configured to slide through its corresponding primary groove without completely detaching therefrom are coupled to firm groove-rail system that allows the removable portion to be reversibly opened and closed. Each of the primary grooves extends along the inside of the back surface of each of the left and right side walls from the interface between the fixed portion and removable portion on the back face wall toward the bottom side wall. Each of the rails that is coupled to each primary groove protrudes from the interior surface of the removable portion.

The channel of each primary groove may preferably extend outward toward the left and right sides of the case. The rails may preferably protrude inward float the outside edges of the left and right sides of the removable portion, respectively.

In some embodiments, each of the left and right side walls may have a secondary groove with a tab situated close to the bottom side wall of the case. In such embodiments, the removable portion may have a detent on each of the left and right sides of the interior surface of the removable portion that is aligned with the corresponding tabs on the left and right side walls. The rails may preferably be discontinuous at the location of the deters on the left and right sides of the interior surface of the removable portion to facilitate use of the case. Each side detent may interface with the corresponding tab on the same side during, operation of the case to prevent the removable portion from being separated from the case under normal use.

In such embodiments, the removable portion is integrally coupled to the fixed portion at the primary grooves but is disconnected from the fixed portion at the outside edges of the left and right side walls. The disconnection between the fixed and removable portions may be imparted by the molding process or may be mechanically imparted after molding during the finishing process by mechanical or laser cutting or another suitable process. The flat exterior surface and surrounding transition surface may extend to both the fixed and removable portions of the case and are defined by the exterior surface of the back face wall on each of those portions.

In some such embodiments, the interface between the fixed portion and the removable portion along the left, right, and bottom side walls may preferably be positioned within the transition surface, such that a portion of the transition surface is part of the fixed portion and a portion of the transition surface is part of the removable portion. In some alternate embodiments, the interface between the fixed portion and the removable portion along the tell, right, and bottom side walls may be positioned at the interface of the transition surface with the exterior surfaces of the left, right, and bottom side walls.

In some embodiments, the removable portion may have a center detent at the bottom that interfaces with a center tab at the bottom of the fixed portion to reversibly lock the case in a closed position when the removable portion is not being extended to access the storage compartment.

In some embodiments, the removable portion includes an interior wall at the top of the removable portion that causes the contents of the storage compartment to be moved as the removable portion is extended to open the storage compartment in such embodiments, the contents held in the storage compartment may be accessed from the front of the ease when the removable compartment is extended.

In other embodiments, the removable portion does not include an interior wall at the top of the removable portion, such that the contents of storage compartment remain in place as the removable portion is extended to open the storage compartment. In such embodiments, the contents held in the storage compartment may be accessed from the back of the case when the removable compartment is extended.

Both the upper and lower portions or alternatively the fixed and removable portions of the case may be formed of a relatively rigid first layer and a relatively less rigid (or softer) second layer co-molded to the more rigid first layer. Thus, for example, the first layer may be formed of a rigid polycarbonate (PC), acrylonitrile butadiene styrene (ABS), liber-reinforced plastic, and/or metal, or the like, and the second layer may be formed of thermoplastic urethane (IPU), thermoplastic elastomer PIE), silicone, and/or natural or synthetic rubber, or the like.

Alternatively, the upper portion or fixed portion may be formed of the relatively rigid first layer co-molded to the relatively less rigid second layer, and the lower portion or removable portion may be formed of the relatively less rigid second layer without the relatively rigid first layer or alternatively may be formed of the relatively rigid first layer without the relatively less rigid second layer.

The first layer may be made of a first material that has a first hardness and the second layer may be made of a second material that has a second hardness that is less than the first hardness. The first layer may have a Shore A durometer hardness that is 50% or more greater than the second layer, 40% or more greater than the second layer, 30% or more greater than the second layer, 20% or more greater than the second layer, or 10% or more greater than the second layer, all ±5%, as measured using the American Society for Testing and Materials (ASTM) standard D2240. The first layer may have aa. Shore A durometer hardness of 100±15, 100±10, or 100±15, or 100, as measured using the American Society for Testing and Materials (ASTM) standard D2240. The second layer may have a Shore A durometer hardness of 45±15.45±10, 45±5, or 45, as measured using the American Society for Testing and Materials (ASTM) standard D2240. It should be understood that the two layers may have a Shore A hardness that comprises any combination of hardnesses described above that is consistent with the teachings herein.

In some embodiments, the first and second layers may be formed of a composition comprising one or more materials selected from the group consisting of polycarbonate, thermoplastic urethane (TPU), thermoplastic elastomer (TPE), acrylonitrile butadiene styrene (ABS), nylon, metal, silicone rubber, or any combination thereof. For example, the first layer, which is the harder of the two layers, may be formed of a composition comprising polycarbonate, a combination of polycarbonate and ABS, nylon, fiber reinforced plastic, and/or metal. The second layer, which is the softer of the two layers, may be formed for example of a composition comprising TPU, TPE, silicone rubber, a combination thereof, or other suitable materials. In some embodiments, the second layer may preferably be an elastic material.

In some preferred embodiments, the first layer may be formed of polycarbonate (PC) and the second layer may be formed of thermoplastic urethane (TPU).

The second layer may further form buttons that are configured to reside over control buttons of the mobile device. In embodiments including a hinge, the second layer may also form the hinge that connects the upper portion and lower portion together. The second layer may also form the some or all of the interior surface of the case including the device and storage compartment. The second layer is further configured to form the front face wall of the case, the interior regions of the side walls of the case, and the exterior regions of the side walls of the case to allow for greater flexibility in the case, which can facilitate insertion and removal of a device into and out of the case.

The interior surface of the case, formed by said second layer, may include a pattern of elevated walls that define apertures capable of providing additional impact zones and hence added protection to the device if the case is dropped with the device secured therein. The pattern of elevated interconnected walls may comprise any arrangement of shapes selected, for example, from the group consisting of a square, octagon, pentagon, rectangle, triangle, circle, hexagon, and heptagon, or a combination thereof. For example, the interconnected walls may comprise walls that form hexagons or portions thereof, which together create a honeycomb wall pattern.

The pattern of elevated interconnected walls may be contiguous or dis-contiguous, may or may not extend to the perimeter regions of the second layer or interior surfaces of the case, may be positioned in discrete regions, or may be grouped and spaced apart from one another in one or more discrete regions. Various patterns comprising one or more shapes may be employed alone or in combination with other patterns, such that one region of the inner surface of the second layer may have one pattern and another region of the inner surface of the second layer may have another pattern.

The first layer may form the flat exterior surface region of the back face wall of the case on both the upper and lower portions or alternatively the fixed and removable portions of the case. The first layer may also form the perimeter region including the transition surface of die hack face wall of the case on both the upper and lower portions or alternatively the fixed and removable portions, of the ease. In embodiments including a groove-rail system, the first layer may also form the components of the groove-rail system. Alternatively, the lower portion or the removable portion, including the flat exterior surface and transition surface extending therefrom, may be formed without the first layer or solely by the less rigid second layer.

An additional decorative third layer may be overlaid to form the external surface of one or both of the upper and lower portions or alternatively the fixed and removable portions to provide additional flexibility in achieving the desired finish. For example, the third layer may be an (IML) layer that is textured and/or colored with patterns or graphics to provide a desired finish such as the look of leather or metal or other desired finish.

In some embodiments, the upper and lower portions or alternatively the fixed and removable portions of the case may further include an insert that may be formed from a fourth layer. The fourth layer may be formed of a relatively less rigid material such as thermoplastic urethane (TIT), thermoplastic elastomer (TPE), and/or natural or synthetic rubber, or the like.

Apertures may be formed in the second layer and a plurality of protrusions may be formed in the first layer that mate with the apertures formed in the second layer and thereby may provide greater integration between the layers.

The case may also include one or more apertures that extend through one or more walls of the case to allow far functionality and facilitate the intended use of the mobile device. For example, the back face wall may include a camera lens aperture that extends through the hack face wall and is configured to extend around the outside of a camera lens window on the hack face of the mobile device. Similarly, one or more of the side walls may include an aperture to allow for manipulation of switches or access to electrical ports or connectors on the mobile device.

Methods of manufacturing a protective case that includes one or more of the various foregoing features are also disclosed herein. Manufacturing steps for a case may, far example, include: (1) molding a first rigid layer in a mold that is configured to define the exterior shape of a first layer, the first layer comprising a back wall and side walls of only an upper portion or fixed portion of the case or of both an upper and lower portion or alternatively a fixed and removable portion of the case; (2), co-molding a second softer layer to the first rigid layer in a mold that is configured to define the exterior shape of the second layer, the second softer layer comprising the interior surfaces of both the back wall and side walls of both the upper and lower portion or alternatively the fixed and removable portion of the case; (3) imparting a separation between the upper portion and lower portion or alternatively the fixed portion and removable portion of the case by molding and/or mechanically cutting the walls between the upper and lower portions or alternatively the fixed and removable portions adjacent to opposing ends of the areas where the upper and lower portions or fixed and removable portions are coupled. The exterior configuration and construction of the case and components thereof as described above and elsewhere herein may be further incorporated into the foregoing manufacturing and molding process. Also, the case may be removed from the mold and finished with a late based outer coating such as those marketed as Soft-Touch coatings or other lipophobic par oleophobic coatings to mitigate against fingerprint residues remaining on the case and to provide a desirable feel to a user of the case.

In operation, the mobile device is inserted into the case. Insertion may be facilitated either directly through the aperture in the more flexible front face wall of, in embodiments with a hinge, by rotating the lower portion backward about the hinge and sliding the mobile device into the case and then rotating and fitting the lower portion about the bottom end region of the inserted mobile device. Rotating the hinge backward also allows access to the storage compartment concealed in the back face wall, such that credit cards, personal identification, or the like may slide in and out through the hinged lower portion, where the hinged lower portion effectively serves as a door to the storage compartment.

In some embodiments, the shape of the exterior of the case including the back wall of the case may be configured to mitigate against accentuating the existence of the storage compartment so that the storage compartment is less noticeable by others. The case may also be formed from one or more opaque materials. In such embodiments, valuable items such as credit cards or personal identification held in the storage compartment may therefore be more secure if the case and mobile device contained therein is lost or stolen.

In some alternate embodiments, both the first and second layers may be transparent or translucent, such that credit cards, personal identification, or other personal items may be visible through the storage compartment and may be readily scanned using a bar code scanner or other electronic scanner. This may facilitate payments or other transactions, such that the credit card, personal identification, or other personal item that a user desires to have scanned does not have to be removed from the storage compartment to be scanned. For example, a user may place an Apple Card™ in the storage compartment which may be scanned for payment without removing the card from the storage compartment. In such embodiments, the first and second layers may preferably be formed of a composition comprising one or more materials selected from the group consisting of polycarbonate, thermoplastic urethane (TPU), the elastomer (IPE), acrylonitrile butadiene styrene (ABS), nylon, silicone rubber, or any combination thereof. For example, the first layer may be formed of a composition comprising a transparent polycarbonate, and the second layer may be formed a composition comprising a transparent TPU.

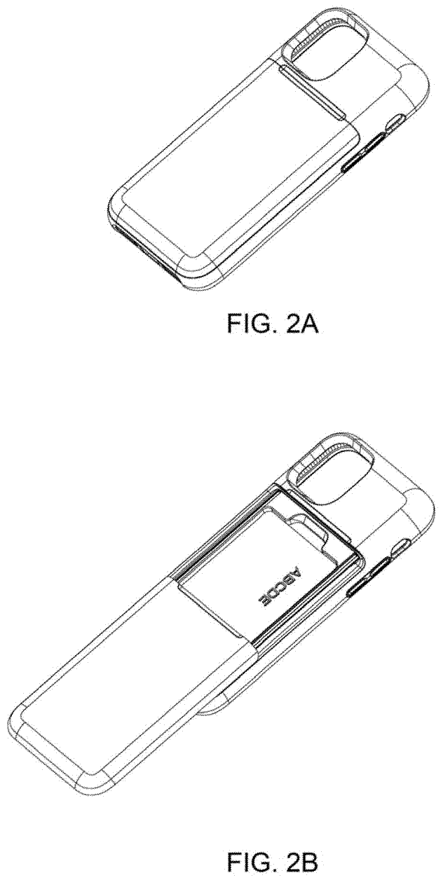

In embodiments with a groove-rail configuration, credit cards, personal identification, or the like that are stored in the storage compartment may be accessed by extending the removable portion. In embodiments where the removable portion does not include an interior wall at the top of the removable portion, the contents held in the storage compartment may be accessed from the back of the case when the removable compartment is extended, as shown in FIG. 2B. In embodiments where the removable portion includes an interior wall at the top attics removable portion, the contents held in the storage compartment may be accessed from the front of the case when the removable compartment is extended, as shown in FIG.

In addition, the case is configured to be capable of being charged using a charging dock. In embodiments with a hinge, rotating the lower portion of the case backward allows for the lower portion of the mobile device (e.g., where the charging and data ports are located) to be directly inserted into a docking or charging cradle without requiring the mobile device to be removed from the case. Moreover, in some embodiments, the large aperture configuration of the case is capable of providing a low profile fit at the bottom end of the case and thereby allows a better fit within the cavity of the docking or charging cradle that may allow the mobile device to fit and functionally dock/charge within the cradle without removal of the case or rotation of the lower portion of the case in embodiments where such rotation is possible.

Each of the walls in the illustrated embodiments include control buttons and/or apertures formed therein. It should be understood however, that the number of buttons and apertures may vary (increase or decrease) and their shape and placement vary to correspond with controls on the mobile device for which the case is configured.

The case is configured and constructed with sufficient flexibility to allow the user to install and remove a mobile device within the case without damaging the case or the mobile device. The flexibility may be implemented via the materials used to construct the case and the configuration of the layers or components.

An additional decorative finishing layer may be included on one or more external surfaces of the case to provide additional flexibility in achieving the desired finish. For example, an in-mold-labeling (IML) layer that is textured and/or colored with patterns or graphics to provide a desired finish such as the look of leather, metal, or another desired finish may be included during the manufacturing process.

Manufacturing steps for the cases disclosed herein may, for example, include: (1) molding a first rigid layer in a mold that is configured to define the exterior shape of a first layer, the first layer comprising a back wall and side walls of only an upper portion or fixed portion of the ease or of both an upper and lower portion or alternatively a fixed portion and removable portion of the case; (2) co-molding a second softer layer to the first rigid layer in a mold that is configured to define the exterior shape of the second layer, the second softer layer comprising the interior surfaces of both the back wall and sidewalls of both the upper and lower portion of the case; (3) imparting a separation between the upper portion and lower portion or alternatively the fixed portion and removable portion of the case by molding and/or mechanically cutting the walls between the upper and lower portions or alternatively the fixed portions and removable portions adjacent to opposing ends of the areas where the upper and lower portions or fixed and removable portions are coupled.

The exterior configuration and construction of the case and components thereof as described in the written specification and drawings may be further incorporated into the foregoing manufacturing and molding process. An IMF type finish may be included in the manufacturing process during molding. The manufacturing process may also include applying a spray or dipped coating over the molded case construct. For example, a latex based outer coating such as those marketed as Soft-Touch coatings or other lipophobic or oleophobic coatings may be applied to the molded case to mitigate against fingerprint residues and provide a desirable feel to the user.

In some alternate embodiments, the protective case is capable of providing user storage for personal items and different user viewing/operating positions while minimizing bulkiness and weight.

Embodiments of the protective ease that are capable of providing different user viewing/operating positions include three primary components: a shell, a front cover, and a flexible spine. The shell is dimensioned and configured to securely and removably retain the electronic device and includes a compartment far storing a personal item, where the compartment is accessible beneath a hingedly attached subpanel. The front cover is dimensioned to approximate the front face of the electronic device with an additional curved perimeter region to partially curve around the front face of the mobile device to protect the entire mobile device and its corners. The flexible spine secures the front cover to the shell.

The shell may include a main body and a detachable subpanel, each of which have an inner surface and an outer surface. The main body defines a cavity for containing the mobile electronic device and the compartment for containing a credit card or personal item. The shell includes an aperture through its back panel that is positioned to partially expose the compartment and is dimensioned to receive the subpanel. The subpanel is positioned to correspond to the aperture formed in the main body and hinged along a first side to the main body and secured on a second side to the flexible spine. One or more attachment protrusions are provided and configured to mechanically secure the subpanel into the aperture of the main body at or near the second side or location to thereby secure the subpanel to the main body of the shell.

When the subpanel is attached or otherwise secured at the second side, the subpanel and main body maintain a fixed relative position and orientation to one another. The subpanel is dimensioned such that when it is positioned within the aperture of the main body, there is a slot or gap between opposing edges of the subpanel and the adjacent edge of the aperture. The shell also includes an indentation or a lip at one or more regions around the aperture that is dimensioned to engage with the corresponding edge or lip regions of the subpanel to prevent the subpanel from swinging into the mobile device compartment formed by the shell and its main body.

The cover may include a front cover panel configured or dimensioned to include a perimeter that is coextensive in dimension with the front face of the mobile device so that it may cover the entirety of the touch screen of the mobile device. The flexible spine connects the front cover panel to the shell via the subpanel. Me flexible spine component may include two opposing flexible inner and outer layers that are overlaid and secured on respective opposing inner and outer sides of the front cover panel, the subpanel, and some or all of the shell, including the panel. The opposing overlaid layers may form the hinge that connects the subpanel to the main body of the shell portion and attaches the shell component to the front cover component. The flexible spine is adapted to allow relative movement between the shell and cover components and to allow the cover to open and close over the shell when the case is opened and closed. The front cover includes a flap or tab at an end opposite the flexible spine, where the flap or tab includes an additional rigid flap insert and a flap-securing fastener such as a snap, magnet, latch, hook, or similar. The flap-securing fastener engages a corresponding fastener receiver such as a magnet, a snap, a latch, a hook, or similar on or in the back of the shell or the side of the shell opposite the flexible spine to secure the front cover in place relative to the shell. The inner face of the cover may include one or more slots or openings in the inner layer so as to create a wallet for credit cards and the like.

The front cover panel, the subpanel the panel, and/or the flap insert may be formed from polycarbonate (PC), thermoplastic urethane (TPU) a thermoplastic elastomer CITE), an acrylonitrile butadiene styrene (ABS), nylon, silicone rubber, a combination thereof, or any other rigid or semi-rigid polymer. The front cover panel, the subpanel, and the panel may alternatively be formed of wood, stone, metal, or other natural materials. The opposing flexible inner and outer layer of the flexible spine may be made of synthetic materials or organic textiles or fabrics. The flexible inner and outer layer may be made of the same material or may be made, of different materials that provide different desirable benefits for the internal and external portions. For example, the internal layer may prioritize friction to minimize credit card or electronic device slipping and softness to avoid scratches, while the outer layer may prioritize durability, water-resistance, or fashionable textures. The inner layer may be configured to cover some, all, or most of the mobile device cavity defined by the shell portion including the inner faces of the main body and subpanels of the shell. The inner layer may also cover the inner face of the front cover panel, which may be configured to be in contact with the front face of the mobile device when the case is in the closed position. Additional layers may also be co-molded or otherwise incorporated into the protective case.

In use, in a closed configuration, the subpanel is positioned and secured within the aperture of the shell and the front cover forms a cover for the shell, partially enclosing the mobile electronic device and a credit card secured behind the mobile electronic device beneath the subpanel. In a flat position, the subpanel remains in position and secured within the aperture of the shell, but the flexible spine lays flat, allowing the front cover to lay flat next to the shell (like an open book). In the flat configuration, the credit card remains secured behind the mobile electronic device and beneath the subpanel. In a stand configuration, the subpanel is disengaged and rotated away from the aperture and the flexible spine is flexed to position an edge of the shell to rest on the front cover, supporting the mobile electronic device in a landscape view. In the stand configuration, a credit card behind the mobile electronic device remains secured between the mobile electronic device and the panel; however, a portion of the credit card may be accessible through the aperture, as the subpanel is rotated away. In the open configuration, the subpanel is disengaged and rotated away from the aperture, revealing a credit card contained in the compartment behind the mobile electronic device, enabling a user to remove the credit card from the compartment through the aperture.

In embodiments of the protective case that are capable of providing different user viewing operating positions, instead of adding weight to the ease to retain the case in the selected viewing position, the case is retained in the selected position as a result of the force resulting from the weight of the mobile device contained within the case. Thus, the case may be manufactured or configured with lightweight materials and so that it would not hold an angled viewing position by itself without the mobile device contained therein. Rather, the case may preferably be configured to be biased to a closed position where the subpanel and main body are generally parallel to one another and not rotated relative to one another. This may be achieved by securing the layers over the main body and subpanel of the shell while the subpanel is closed and thus the overlaid layers will exhibit a natural tension when the subpanel is opened and therefore bias the subpanel into the closed position.

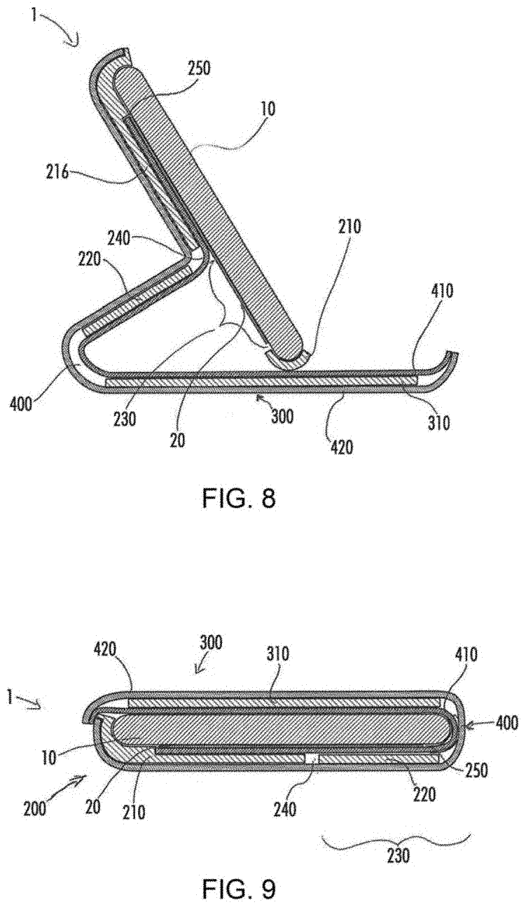

As shown in FIGS. 8-9, the protective ease 1 is generally configured to receive and protect a mobile device 10. The case 1 generally includes a shell 200, where the shell 200 includes a main body 219 and a subpanel. 229, and a front cover 300 that includes a front cover panel 310 that is attached to the shell 200 via a flexible spine 400. A flexible inner layer 419 and outer layer 420 overlay and are secured to opposing sides of the main body 210, the subpanel 220, front cover panel 310, and a flap insert 321, connecting the components as a single continuous case 1 and enabling relative motion between the components. The flexible inner layer 410 and flexible outer layer 420 are secured together between other components, forming the hinge 240 between the main body 210 and the subpanel 220, forming the flexible spine 400 between the subpanel 220 and the front cover 300, and allowing the flap or tab 320 to move relative to the front cover 300.

The protective case 1 may be for mobile electronic device 10 that is in the form of a tablet, a smartphone or mobile phone, an MP3 audio player, a gaming device, or another portable handheld electronic device. Such mobile devices 10 typically include a front face and a hack face, where the difference between the two faces defines the height or thickness of the mobile device 10, a perimeter defined by top, bottom, right, and left sides residing between the front and back faces, and corners defined at the intersecting regions of the sides. The entirety, most, or a portion of the front face of the mobile device 14) may be comprised of a touch screen, possibly including one or more buttons and/or a biometric scanner. Screens may be provided on other sides as well, including the back face. The device 10 may have one or more buttons, controls, user interfaces, and/or ports included along its perimeter walls and a camera, flash, and speaker or microphone port on its back face.

The shell component 200 is generally defined by a front (internal cavity) surface and an opposing rear surface, left and right sides, and top and bottom ends. The front side or face of the shell 200 defines a cavity 255 that is configured to receive and retain the portable electronic device as well as a compartment 250 that is configured and dimensioned to receive and retain a personal item 20 (e.g., an identification card, credit card, debit card, medical insurance card, money, or other item), while allowing a user to access the touchscreen on the front face of the electronic device 10 and to control interfaces on the device 10. The shell component 200 may be in the form of contoured molded polymer sub-portions including a main body 210 and a separate subpanel 220 corresponding to an aperture in the main body.

The main body 210 may also include additional apertures including a camera lens aperture 226 and a speaker and/or microphone aperture 228. Apertures may also be included in the subpanel 240, for example if the subpanel is configured to cover features on the mobile device. Perimeter regions in the shell 200 that reside between one or more of the corners may be removed. Mid-section regions of the shell 200 may be removed to allow for user utilization of device features that are located on the side walls and/or back face of the mobile device 10.

The main body 210 and subpanel 220 each have inner surfaces and outer surfaces respectively. The inner layer 410 and outer layer 420 sandwich the main body 210 and subpanel 220, with the inner layer 410 secured to the inner surfaces of the main body and subpanel and the outer layer 420 secured to the outer layer of the main body and subpanel. The inner 410 and outer layers 420 may be attached or adhered to one another and the interposed components (e.g., the shell panels and cover panel) via any suitable method including mechanical stitching, chemical adhesion, glue, heat sealing, or a combination thereof. Additional layers may be secured between either of the layers 410 and 420 and any of the interposed or secured elements 210, 220, 300, and 321 or even between the layers 410 and 420 at the hinge 240 or flexible spine 400.

The aperture 230 through the back surface of the shell is positioned to partially expose the personal item compartment 250 and is dimensioned to receive the subpanel. The main body 210 and the subpanel 220 include overlapping lips or edges configured to provide a mechanical stop and keep the subpanel 220 from rotating into the cavity 255 and compartment 250 through the aperture. One or more attachment protrusions 260 are provided and configured to mechanically secure the subpanel 220 into the aperture 230 of the main body 210 at or near the second side or location to thereby secure the subpanel 220 to the main body 210 of the shell 200. The combination of the hinged connection 240 on one side and the mechanical detents or attachment protrusions 260 on the other side of the aperture 230 allow the subpanel 229 to rotatably lock and unlock into and out of the main body 219.

The subpanel 220 is positioned to correspond to the aperture formed in the main body 210 and a hinge 240, formed by the inner layer 410 and outer layer secured together between the main body 410 and the subpanel 220, connects the subpanel 220 along a first side to the main body 210 and a flexible spine 400 formed by the inner layer 410 and outer layer secured together between the subpanel 229 and the front cover panel 310, secures the subpanel 220 to the front cover panel 310 on a second side. In other embodiments, only an inner layer 410 may be used without an outer layer 420 or an outer layer 420 may be used without an inner layer 410 to connect the components of the case 1. Alternatively, the construction of the elements may be reversed from that as described, to include a single flexible layer sandwiched between the rigid elements, but otherwise acting as described herein. Instead of or in addition to relying or the hinge 240 and flexible spire 400 formed by the joined inner layer 410 and outer layer 420, the subpanel 220 may be secured to the main body 210 by other rotatable connections or conventional hinge connections, including one or more of a living hinge, a pin and socket, or in some cases, the subpanel 220 may be formed of a flexible material.

In the illustrated embodiment, the front face of the main body 210 of the shell 200 defines a cavity that is configured to snap onto and retain an electronic device 10 (not shown) securely within the cavity 255 and a credit card compartment 250 defined by the contoured walls of the main panel 220. Notably, the shell 200 is configured such that the main body 210 alone, without the subpanel 220, defines a retention cavity 255 that covers at least partially all or some of the four sides and at least a portion of the hack face of the mobile device 10 and is adapted to snap onto or over the mobile device 1 and securely retain the electronic device 10 that it is configured to receive.

The personal item 20 is positioned in the compartment 250 behind the cavity 255, so that an electronic device 10 retained in the cavil 255 presses the personal item 20 against the front wall of the shell 200. The personal item 20 may be retrieved from the compartment 250 by either removing the mobile electronic device 10 from the cavity 255 to expose the compartment 250, or by rotating the subpanel 220 away from the main body 210 to expose the aperture 230, allowing a user to retrieve the personal item 20 from the compartment 250 through the aperture 230, even when an electronic device 10 is retained in the cavity 255. The subpanel 220, therefore, is not required for retention of the mobile electronic device 10 in the cavity 255 of the shell 200, but is required to secure a personal item 20 in the compartment 250 behind the cavity 255.

The front cover component 300 is configured to cover the front face of the mobile device 10 when the case 1 is completely closed. The front cover 300 is defined by a front (internal) surface and an opposing rear surface, left, right, top and bottom edges or sides that correspond to the front, back, left, right, top, and bottom sides of the shell 200 when the case 1 is in the completely closed position and the front cover 300 is on top of the shell 200. The front cover component 300 includes a front cover panel 310, overlaid on opposing sides with the inner layer 410 and the outer layer 420. One or more slots or openings 330 may be formed into the inner layer 410 over the front co per panel 310 to form a wallet or credit card holder. Additional loops or pockets 340 may be formed on the front or rear surfaces of the front cover 300.

The star ponents of the shell 209 may be made of any suitable material. For example, the shell components 210 and 220 may be manufactured via injection molding using a suitable polymer such as polycarbonate and/or fiber (e.g., carbon or Kevlar) reinforced plastic or polymers, in other embodiments, case 1 may be constructed of natural materials including, metal, hone, wood, or stone. The main body 210 of the shell 200 may be formed of the same or different material from the subpanel 220 of the shell 200. For example, the main body 210 may be formed of a more rigid material than the subpanel or vice versa. Similarly the front cover panel and flap insert 321 may be made of the same or different materials from the components of the shell 200. In some embodiments, securing fasteners such as flap 325 may require additional or specific materials, such as a magnetic flap 325 securing to a magnetic shell 270, in some embodiments, both the flap 325 and shell 270 are magnetized, while in other embodiments only, one of the flap 325 and shell 270 is magnetized while the other is a ferromagnetic material such as iron.

In order to bias the subpanel to the closed position, the layers 410 and 420 may be adhered to each of the shell body 210 and subpanel 220 when they are oriented in the cored position. The inner layer 410 and outer layer 420 will therefore be biased (perhaps only slightly) against the subpanel 220 opening or hinging away from the main body 210 of the shell 200.

The inner surfaces of the main body acid subpanel of the shell 200 include recessed regions or attachment areas dimensioned to receive correspondingly dimensioned inner layer 410 regions. Similarly, the outer surfaces of the main body and subpanel of the shell 200 include recessed regions dimensioned to receive correspondingly dimensioned outer layer 420 regions. Incorporating recessed regions in the inner and outer faces mitigates peeling of the flexible inner 410 and outer 420 layers. Due to the recessed regions, the outer surfaces of the inner 410 and outer 420 layers are flush with or lower than the outer surfaces of the adjacent surrounding more rigid elements of the case 1.

In a stand configuration, the subpanel 220 may be disengaged by the user from the attachment protrusions 269 of the main body 210, allowing the main body 210 to pivot at the hinge 240 (relative to the subpanel 220), folding the case 1 over itself to form a different viewing or operating position as illustrated in FIGS. 8-9. Additionally, with the subpanel 220 pivoted away from the main body 210, the main body 210 can rotate at the hinge 240 away from the flexible spine 400 and over the inner face of the front cover 300. The proximate edge of the main body 210 of the shell 200 (i.e., the left side or edge) can be positioned to rest atop the inner face of the front cover 300 in a conveniently angled landscape viewing position or stand configuration. The weight of the mobile electronic device 10 retained in the shell 200 maintains the case 1 in the desired stand configuration. By using the weight of the mobile device 10 to provide the added weight or force necessary to bias the case t into a desired viewing or operating position, the case 1 can be manufactured using lighter materials.

A method of manufacturing the disclosed case is also disclosed herein. A shell 200, including a main body 210 and subpanel 220, and, a front cover 300 as described above may be molded or formed and then overlaid between flexible inner and outer layers 410 and 420. A hinge 240, connecting the subpanel 220 over an aperture 230 in the main body 210 of the shell 200, is provided between the subpanel 220 and the main body 210 along a first side or edge. The hinge 240 may be formed by the overlaid inner and/or outer layers 410 and 420. The inner 410 and/or outer 420 layers may be overlaid when the subpanel 220 and the main body 210 are in the closed position to bias the case into the closed position.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intern that any claim set forth below requires more features than are expressly recited in that claim. Rather, as the following claims reflect, inventive aspects may reside in a combination of fewer than all features of any single foregoing disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A protective case air a mobile device configured to be user removable from said mobile device, wherein the ease has interior and exterior surfaces, front and opposing back face walls, and left, right, bottom, and top side walls, the case comprising:
a fixed portion; and
a removable portion that includes an interior wall at its top end and that is coupled to the fixed portion at the back face wall by a groove-rail system;
wherein the groove-rail system comprises a primary groove formed from an extension that protrudes from the back surface of each of the left and right side walls and a corresponding rail on each side of the removable portion that is configured to slide through its corresponding primary groove without completely detaching therefrom; and
wherein a storage compartment is formed between the fixed portion and the removable portion.

2. A protective ease for a mobile device configured to be user removable from said mobile device, wherein the case has interior and exterior surfaces, front and opposing back face walls, and fell, right, bottom, and top side walls, the case comprising:
a fixed portion; and
a removable portion that is coupled to the fixed portion at the back face wall by a groove-rail system;
wherein the groove-rail system comprises a primary groove formed from an extension that protrudes from the back surface of each of the left and right side walls and a corresponding rail on each side of the removable portion that is configured to slide through its corresponding primary groove without completely detaching therefrom;
wherein a storage compartment is formed between the fixed portion and the removable portion; and
wherein the removable portion is transparent or translucent.
